(19) United States
(12) Patent Application Publication
(10) Pub. No.: US 2024/0400141 A1
(43) Pub. Date: Dec. 5, 2024

(54) POOL CLEANING ROBOT WITH TRACK LAP STRUCTURE

(71) Applicant: SUZHOU SMOROBOT TECHNOLOGY CO., LTD., Suzhou (CN)

(72) Inventors: Jie TANG, Suzhou (CN); Yaming TANG, Suzhou (CN)

(21) Appl. No.: 18/798,951

(22) Filed: Aug. 9, 2024

Related U.S. Application Data
(63) Continuation of application No. PCT/CN2022/075670, filed on Feb. 9, 2022.

(51) Int. Cl. B62D 55/12; B62D 55/26; E04H 4/16

(52) U.S. Cl. CPC B62D 55/12; B62D 55/26; E04H 4/1654

(57) ABSTRACT

One or more embodiments of the present disclosure provide a pool cleaning robot with a track lap structure, including a cleaning body and a drive mechanism. The drive mechanism includes: a wheel, the wheel is rotatably arranged on the cleaning body, the wheel includes a track lap structure and a first engaging structure, the track lap structure and the first engaging structure are sequentially arranged in an axial direction of the wheel, so as to form a limiting structure on the wheel or between the wheel and the cleaning body; and a track, the track is sleeved outside the wheel, and at least part of the track is engaged with the first engaging structure, so that the track is driven by the wheel to move, where an inner surface of the track is provided with an anti-detachment structure, and the anti-detachment structure is lapped on the track lap structure. A position of the track is fixed by the cooperation of the anti-detachment structure provided on the inner surface of the track with the limiting structure, thereby avoiding the problem of loose track.

### FIELD OF THE INVENTION

Embodiments of the present disclosure relate to the technical field of cleaning apparatuses, in particular to a pool cleaning robot with a track lap structure.

### BACKGROUND OF THE INVENTION

The pool cleaning robot is a cleaning robot produced for the needs of pool cleaning, which may complete the repeated cleaning of the bottom and walls of a pool and the action of filtering water in the pool. During working, the pool cleaning robot cleans contaminants on the surface of the pool through rolling of a roller brush.

In order to ensure that the pool cleaning robot does not slip or has other problems when moving underwater or on a wall surface, the pool cleaning robot is equipped with a track to drive the pool cleaning robot to move reliably and smoothly. However, with the use of the pool cleaning robot, the track may come loose.

### SUMMARY OF THE INVENTION

In order to solve the above problem, embodiments of the present disclosure provide a pool cleaning robot with a track lap structure, so as to at least partially solve the above problem.

One or more embodiments of the present disclosure provide a pool cleaning robot with a track lap structure, including a cleaning body and a drive mechanism. The drive mechanism includes: a wheel, the wheel is rotatably arranged on the cleaning body, the wheel includes a track lap structure and a first engaging structure, the track lap structure and the first engaging structure are sequentially arranged in an axial direction of the wheel, so as to form a limiting structure on the wheel or between the wheel and the cleaning body; and a track, the track is sleeved outside the wheel, and at least part of the track is engaged with the first engaging structure, so that the track is driven by the wheel to move, where an inner surface of the track is provided with an anti-detachment structure, and the anti-detachment structure is lapped on the track lap structure.

In one or more embodiments, the wheel further includes a wheel body, the first engaging structure is arranged on an outer peripheral surface of the wheel body and protrudes along a radial direction of the wheel body, a width of the first engaging structure in the axial direction of the wheel is smaller than a width of the wheel body in the axial direction, so as to form the track lap structure; when the wheel body is rotatably connected to the cleaning body, the limiting structure is formed by the first engaging structure, the track lap structure and the cleaning body, and the anti-detachment structure provided on the inner surface of the track extends into the limiting structure.

In one or more embodiments, the cleaning body includes a bearing casing, and when the wheel is connected to the cleaning body, the limiting structure is formed by the first engaging structure, the track lap structure and the bearing casing, and the anti-detachment structure provided on the inner surface of the track extends into the limiting structure.

In one or more embodiments, the cleaning body includes a protective cover plate, and the protective cover plate is detachably connected to the wheel, the limiting structure is formed by the first engaging structure, the track lap structure and the protective cover plate, and the anti-detachment structure provided on the inner surface of the track extends into the limiting structure.

In one or more embodiments, the wheel further includes a baffle plate, the baffle plate is arranged on the wheel body, and the baffle plate protrudes along the radial direction of the wheel body, the limiting structure is formed by the first engaging structure, the track lap structure and the baffle plate, and the anti-detachment structure provided on the inner surface of the track extends into the limiting structure.

In one or more embodiments, the pool cleaning robot further includes a decorative plate, and the decorative plate is sealed to the baffle plate and the track to prevent contaminants from entering between the wheel and the track.

In one or more embodiments, the limiting structure is a limiting groove, and the anti-detachment structure provided on the inner surface of the track is a limiting protrusion fitted with the limiting groove.

In one or more embodiments, the first engaging structure includes engaging grooves distributed at intervals along a circumferential direction of the wheel, and at least part of the track that is fitted with the first engaging structure is engaging teeth, the engaging teeth are provided on the inner surface of the track, and are fitted with the engaging grooves.

In one or more embodiments, a depth of the engaging grooves in a radial direction of the wheel is smaller than a depth of the limiting groove in the radial direction of the wheel, and a height of the engaging teeth is smaller than a height of the limiting protrusion.

In one or more embodiments, the engaging teeth and the limiting protrusion are sequentially arranged in a width direction of the track.

In one or more embodiments, the limiting structure is continuous in a circumferential direction of the wheel.

In one or more embodiments, an outer peripheral surface of the track is provided with anti-skid protrusions, and the anti-skid protrusions are sequentially arranged at intervals along a circumferential direction of the track.

The pool cleaning robot with a track lap structure provided by the embodiments of the present disclosure, the cleaning body moves on a surface of the pool through the drive mechanism to clean the pool; the drive mechanism includes the wheel and the track, the wheel is rotatably arranged on the cleaning body, the track lap structure and the first engaging structure of the wheel are sequentially arranged in the axial direction of the wheel so as to form the limiting structure on the wheel or between the wheel and the cleaning body, so that when the track is engaged with the first engaging structure, the anti-detachment structure provided on the inner surface of the track is lapped on the track lap structure, so as to fall within the limiting structure; at least part of the track is engaged with the first engaging structure of the wheel, so that the track is driven by the wheel to move, so as to drive the cleaning body to move; a position of the track is fixed by the cooperation of the anti-detachment structure provided on the inner surface of the track with the limiting structure, thereby avoiding the problem of loose track.

### BRIEF DESCRIPTION OF DRAWINGS

The following accompanying drawings are only intended to describe and explain the present disclosure schematically, and do not limit the scope of the present disclosure. In which,

FIG. 1 is a schematic structural diagram of a pool cleaning robot with a track lap structure according to the present disclosure;

FIG. 2 is a schematic structural diagram of a track of a pool cleaning robot with a track lap structure according to the present disclosure;

FIG. 3 is a main view schematic structural diagram of a pool cleaning robot with a track lap structure according to the present disclosure;

FIG. 4 is a schematic three-dimensional structural diagram of cooperation of a wheel and a protective cover plate of a pool cleaning robot with a track lap structure according to the present disclosure;

FIG. 5 is a schematic three-dimensional structural diagram of a wheel with a baffle plate of a pool cleaning robot with a track lap structure according to the present disclosure;

FIG. 6 is a schematic structural diagram of cooperation of a track lap structure, a wheel body and a first engaging structure of a pool cleaning robot with a track lap structure according to the present disclosure; and

FIG. 7 is an exploded view of a pool cleaning robot with a track lap structure according to the present disclosure.

### DESCRIPTION OF REFERENCE NUMERALS

1. Cleaning body; 11. Bearing casing; 113. Upper casing; 114. Chassis; 115. Water inlet; 116. Water outlet; 117. Movable flip; 12. Protective cover plate; 13. Filtering structure; 14. Sealed cabin; 2. Drive mechanism; 21. Wheel; 211. First engaging structure; 212. Limiting structure; 213. Baffle plate; 214. Track lap structure; 22. Track; 221. Engaging tooth; 222. Limiting protrusion; 3. Roller brush mechanism.

### DETAILED DESCRIPTION OF THE INVENTION

In order to have a clearer understanding of the technical features, objectives and effects of embodiments of the present disclosure, specific implementations of the embodiments of the present disclosure will now be described with reference to the accompanying drawings.

As used herein, “schematic” indicates “serving as an example, instance, or description” and any illustration, implementation described herein as “schematic” should not be construed as a preferred or more advantageous technical solution.

For the sake of brevity of the drawings, the drawings only schematically show parts related to the present disclosure, and they do not represent the actual structure as a product. In addition, in order to make the drawings concise and easy to understand, in some drawings, for components having the same structure or function, only one or more of the components are schematically depicted, or only one or more of the components are marked.

Before describing a structure of a pool cleaning robot with a track lap structure (hereinafter referred to as pool cleaning robot) according to the embodiments of the present disclosure, an application scenario of the pool cleaning robot is briefly described for easy understanding.

Referring to FIG. 1 to FIG. 7, the pool cleaning robot generally includes a cleaning body 1, a roller brush mechanism 3 and a drive mechanism 2. The drive mechanism 2 includes a wheel 21 and a track 22, and the engaged track 2 is driven by rotation of the wheel 21, so as to drive the cleaning body 1 to move on a bottom wall and side walls of a pool. The roller brush mechanism 3 is arranged on the cleaning body 1, and the roller brush mechanism 3 is driven to rotate when the drive mechanism 2 drives the cleaning body 1 to move, so as to clean contaminants adhering to the bottom wall and the side walls of the pool.

In order to collect the contaminants in the pool, the cleaning body 1 includes a bearing casing 11, a filtering structure 13, a sealed cabin 14 and the like. The bearing casing 11 includes an upper casing 113 and a chassis 114, and the upper casing 113 and the chassis 114 are detachably connected. The chassis 114 is provided with a water inlet 115, the upper casing 113 is provided with a water outlet 116, and a reversible movable flip 117 may also be provided on the upper casing 113. The filtering structure 13 is arranged between the water inlet 115 and the water outlet 116 to ensure that water and/or contaminants entering from the water inlet 115 are filtered by the filtering structure 13, leaving the contaminants in the bearing casing 11. The water is separated from the contaminants, and the filtered water is discharged from the water outlet 116.

The drive mechanism 2 drives the engaged track 22 by the rotation of the wheel 21, to drive the cleaning body 1 to move on the bottom wall and the side walls of the pool. With the use of the pool cleaning robot, the problem of looseness of the track 22 may occur. Therefore, in order to solve the above technical problem, the embodiments of the present disclosure provide a pool cleaning robot with a track lap structure, to fix a position of the track 22, so as to avoid the problem of the track 22 coming loose.

Referring to FIG. 1 to FIG. 7, one or more embodiments of the present disclosure provide a pool cleaning robot with a track lap structure, and the pool cleaning robot includes a cleaning body 1 and a drive mechanism 2. The drive mechanism 2 includes a wheel 21 and a track 22, the wheel 21 is rotatably arranged on the cleaning body 1, the wheel 21 includes a track lap structure 214 and a first engaging structure 211, the track lap structure 214 and the first engaging structure 211 are sequentially arranged in an axial direction of the wheel 21, so as to form a limiting structure 212 on the wheel or between the wheel and the cleaning body 1; and the track 22 is sleeved outside the wheel 21, and at least part of the track 22 is engaged with the first engaging structure 211, so that the track 22 is driven by the wheel 21 to move, where an inner surface of the track 22 is provided with an anti-detachment structure, and the anti-detachment structure is lapped on the track lap structure 214, to cooperate with the track lap structure 214 to prevent the track 22 from falling off.

The wheel 21 of the embodiments of the present disclosure includes the track lap structure 214 and the first engaging structure 211, and the track lap structure 214 and the first engaging structure 211 are sequentially arranged in the axial direction of the wheel 21, so that the position of the track 22 may be limited without additionally increasing a diameter of the wheel, and it may not interfere with the rotation of the wheel.

In an implementation, the limiting structure 212 is continuous in a circumferential direction of the wheel 21, thereby ensuring that when the wheel 21 rotates to various angles, the track 22 may be prevented from coming off by using the continuous limiting structure 212 in the circumferential direction of the wheel 21.

For example, the limiting structure 212 may be a limiting groove, and the anti-detachment structure provided on the inner surface of the track 22 may be a limiting protrusion 222 fitted with the limiting groove. The position of the track 22 may be limited by the cooperation of the limiting groove and the limiting protrusion 222, thereby avoiding the problem of the track 22 coming loose.

In an implementation, the first engaging structure 211 includes engaging grooves (that is, teeth grooves of gears) distributed at intervals along the circumferential direction of the wheel 21, and at least part of the track 22 that is fitted with the first engaging structure 211 is engaging teeth 221, the engaging teeth 221 are provided on the inner surface of the track 22, and are fitted with the engaging grooves. The engaging grooves of the first engaging structure 211 cooperate with the engaging teeth 221 on the inner surface of the track 22, and when the wheel 21 rotates, the track 22 is driven to move, so as to drive the pool robot to move on the surface of the pool.

In order to effectively prevent the track from falling off, a depth of the engaging grooves in a radial direction of the wheel 21 is smaller than a depth of the limiting groove in the radial direction of the wheel 21, in other words, the depth of the limiting groove is greater than the depth of the engaging grooves, and a height of the engaging teeth 221 is smaller than a height of the limiting protrusion 222. In this way, when the engaging grooves of the wheel 21 are engaged with the engaging teeth 221 of the track 22, the limiting protrusion 222 of the track 22 falls into the limiting groove, so that during transmission of the wheel 21 and the track 22, even if the track 22 becomes loose and is subjected to an axial force, which causes the track 22 to move relative to the wheel 21 in the axial direction of the wheel 21, since the contact of the limiting protrusion 222 with groove walls of the limiting groove forms a stop for the track 22, the track 22 is prevented from falling off.

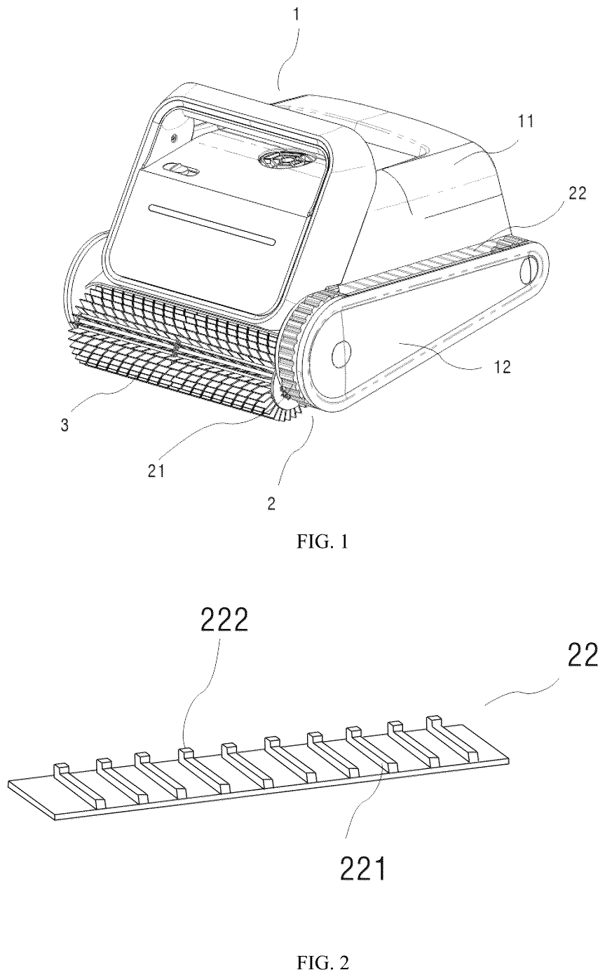

Referring to FIG. 2, in an implementation, the engaging teeth 221 and the limiting protrusion 222 of the track 22 are sequentially arranged in a width direction of the track 22, so that they may be adapted to various arrangements of the wheel 21.

In order to make the track move more smoothly in the pool, an outer peripheral surface of the track 22 may also be provided with anti-skid protrusions, and the anti-skid protrusions are sequentially arranged at intervals along a circumferential direction of the track 22. The anti-skid protrusions may be tooth-shaped. When the pool robot moves on the surface of the pool, the anti-skid protrusions may prevent the track 22 from sideslipping on the surface of the pool, so that the pool robot may move reliably and smoothly.

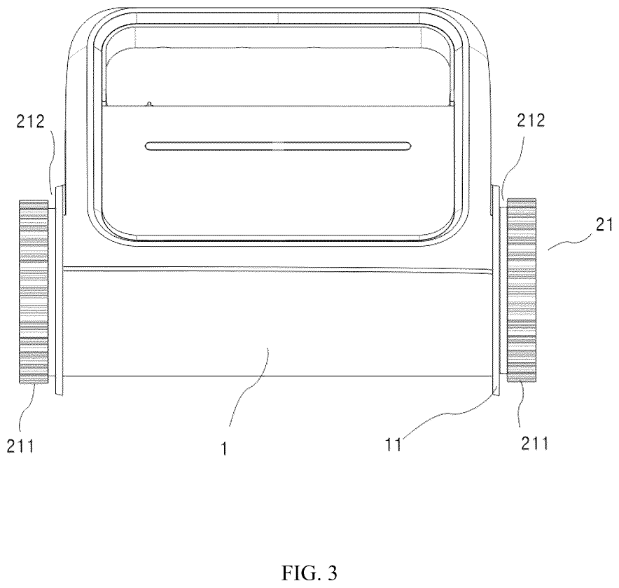

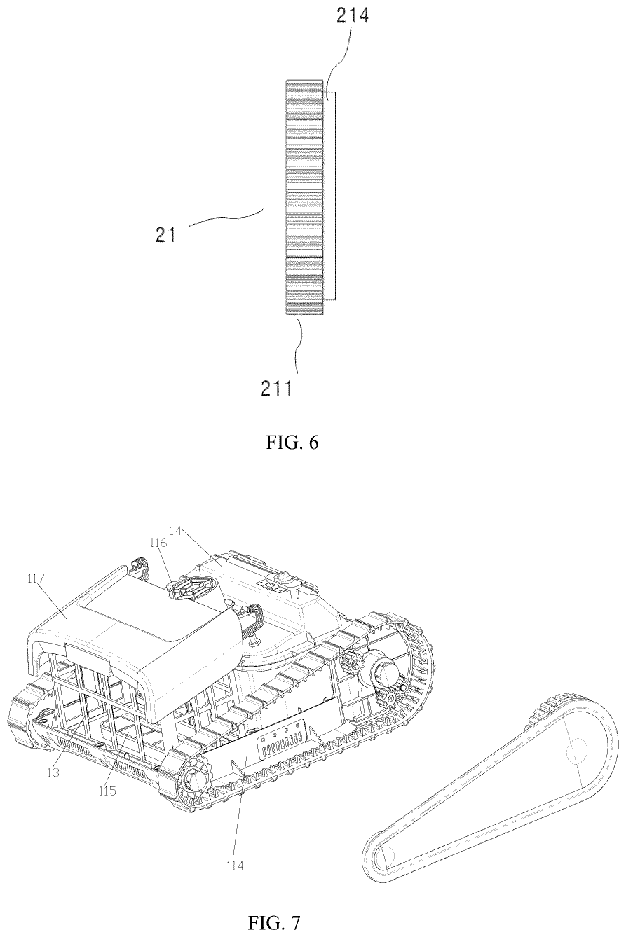

Referring to FIG. 3 and FIG. 6, in a specific implementation, the wheel 21 further includes a wheel body, the first engaging structure 211 is arranged on an outer peripheral surface of the wheel body and protrudes along a radial direction of the wheel body. For example, the first engaging structure 211 may be a plurality of gear teeth, each of which is parallel to an axis of the wheel 21 and the gear teeth are sequentially arranged on the outer peripheral surface of the wheel body. The wheel 21 may be engaged with the track 22 through the gear teeth to drive the track 22 to move.

A width of the first engaging structure 211 in the axial direction of the wheel 21 is smaller than a width of the wheel body in the axial direction, so as to form the track lap structure 214. In one case, the track lap structure 214 may cooperate with other structures to form the limiting structure. Or, in another case, the track lap structure 214 may cooperate with other structures of the wheel 21 itself to form the limiting groove.

For example, for the case where the track lap structure 214 may cooperate with other structures of the wheel 21 itself to form the limiting groove, referring to FIG. 5, the wheel 21 may further include a baffle plate 213, the baffle plate 213 is arranged on the wheel body, and is arranged spaced apart from the first engaging structure 211 in the axial direction of the wheel 21. In this way, one side of the track lap structure 214 stops the track through the baffle plate 213, and the other side stops the track through the first engaging structure 211.

The baffle plate 213 may be set as a detachable structure, which is more convenient for replacement and maintenance, and may also be set as an integrally formed baffle plate 213 to make the connection more stable.

The baffle plate 213 protrudes along the radial direction of the wheel body, the baffle plate 213 may be a continuous annular baffle plate 213, or may be a plurality of teeth protruding along the radial direction of the wheel body arranged at intervals. The wheel uses the baffle plate 213, the track lap structure 214 and the first engaging structure 211 to form the limiting structure 212. In this way, the structure is simpler, and less material is used, which saves costs.

In this case, in order to prevent contaminants from entering, the pool cleaning robot further includes a decorative plate (not shown in the figure), and the decorative plate is relatively sealed to the baffle plate 213 and the track 22 to prevent the contaminants from entering between the wheel 21 and the track 22, to reduce debris twisting into the track, thereby improving overall moving efficiency and cleaning efficiency. For example, the decorative plate may be connected to the wheel 21, or fastened to the baffle plate, or connected to the cleaning body, as long as the decorative plate can be installed.

For the case where the track lap structure 214 may cooperate with other structures to form the limiting structure, as shown in FIG. 3, the cleaning body 1 includes a bearing casing 11, and when the wheel 21 is connected to the cleaning body 1, the limiting structure 212 is formed by the first engaging structure 211, the track lap structure 214 and the bearing casing 11. The position where the wheel 21 is connected to the cleaning body 1 may be disposed inside the bearing casing 11 or outside the bearing casing 11.

When the wheel 21 is disposed inside the bearing casing 11, the first engaging structure 211, the track lap structure 214 and an inner surface of the bearing casing 11 form the limiting structure 212.

When the wheel 21 is disposed outside the bearing casing 11, the first engaging structure 211, the track lap structure 214 and an outer surface of the bearing casing 11 form the limiting structure 212. The limiting structure 212 is formed through the cooperation between the track lap structure 214 and the inner wall or the outer wall of the bearing casing 11, so that no additional structure is required to be provided on the wheel 21, thereby reducing a production cost and processing difficulty.

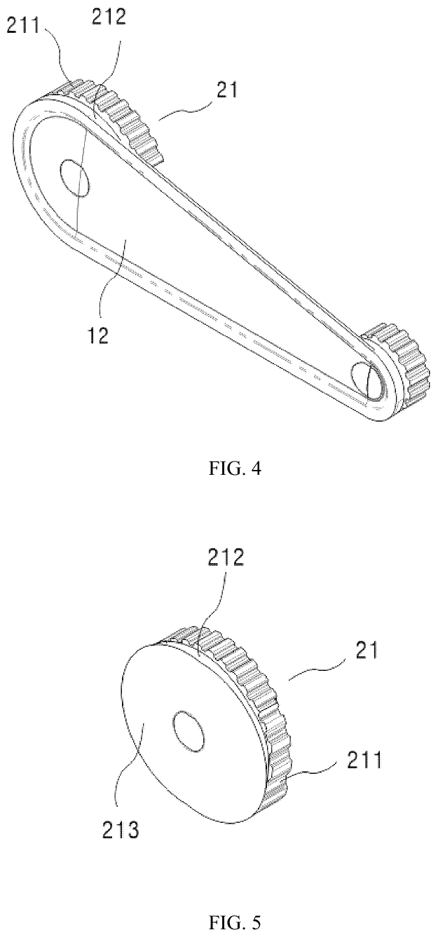

Or, as shown in FIG. 4, the cleaning body 1 may further include a protective cover plate 12, and the protective cover plate 12 is detachably connected to the wheel 21, the limiting structure 212 is formed by the first engaging structure 211, the track lap structure 214 and the protective cover plate 12. The anti-detachment structure provided on the inner surface of the track 22 extends into the limiting structure 212, so as to limit the position of the track 22. The protective cover plate 12 can not only cooperate with the track lap structure 214 to form the limiting structure 212, but also can protect the wheel 21 to prevent contaminants from entering between the wheel 21 and the track 22, so as to protect the wheel 21 and the track 22.

The wheel 21 may be a driving wheel of the pool cleaning robot, or a driven wheel of the pool cleaning robot, or the driving wheel and the driven wheel are the wheels 21 of this structure, in order to better limit the position of the track 22 and effectively prevent the track 22 from falling off from the axial direction of the wheel 21 during use.

It should be understood that although this specification is described according to the embodiments, not each embodiment only includes an independent technical solution, and this description in the specification is only for the sake of clarity, and those skilled in the art should take the specification as a whole, the technical solutions in the embodiments may also be appropriately combined to form other implementations that can be understood by those skilled in the art.

The above description is only illustrative specific implementations of the embodiments of the present disclosure, and are not intended to limit the scope of the embodiments of the present disclosure. Any equivalent changes, modifications and combinations made by those skilled in the art without departing from the concept and principles of the embodiments of the present disclosure shall fall within the protection scope of the embodiments of the present disclosure.

1. A pool cleaning robot with a track lap structure, comprising:
a cleaning body (1), configured to clean contaminants in a pool;
a drive mechanism (2), the drive mechanism (2) comprising:
a wheel (21), the wheel (21) being rotatably arranged on the cleaning body (1), the wheel (21) comprising a track lap structure (214) and a first engaging structure (211), the track lap structure (214) and the first engaging structure (211) being sequentially arranged in an axial direction of the wheel (21), so as to form a limiting structure (212) on the wheel (21) or between the wheel (21) and the cleaning body (1); and
a track (22), the track (22) being sleeved outside the wheel (21), and at least part of the track (22) being engaged with the first engaging structure (211), so that the track is driven by the wheel (21) to move, wherein an inner surface of the track (22) is provided with an anti-detachment structure, and the anti-detachment structure is lapped on the track lap structure (214).

2. The pool cleaning robot with a track lap structure according to claim 1, wherein the wheel (21) further comprises a wheel body, the first engaging structure (211) is arranged on an outer peripheral surface of the wheel body and protrudes along a radial direction of the wheel body, a width of the first engaging structure (211) in the axial direction of the wheel (21) is smaller than a width of the wheel body in the axial direction, so as to form the track lap structure (214); when the wheel body is rotatably connected to the cleaning body (1), the limiting structure (212) is formed by the first engaging structure (211), the track lap structure (214) and the cleaning body (1), and the anti-detachment structure provided on the inner surface of the track (22) extends into the limiting structure (212).

3. The pool cleaning robot with a track lap structure according to claim 2, wherein the cleaning body (1) comprises a bearing casing (11), and when the wheel (21) is connected to the cleaning body (1), the limiting structure (212) is formed by the first engaging structure (211), the track lap structure (214) and the bearing casing (11), and the anti-detachment structure provided on the inner surface of the track (22) extends into the limiting structure (212).

4. The pool cleaning robot with a track lap structure according to claim 2, wherein the cleaning body (1) comprises a protective cover plate (12), and the protective cover plate (12) is detachably connected to the wheel (21), the limiting structure (212) is formed by the first engaging structure (211), the track lap structure (214) and the protective cover plate (12), and the anti-detachment structure provided on the inner surface of the track (22) extends into the limiting structure (212).

5. The pool cleaning robot with a track lap structure according to claim 2, wherein the wheel (21) further comprises a baffle plate (213), the baffle plate (213) is arranged on the wheel body, and the baffle plate (213) protrudes along the radial direction of the wheel body, the limiting structure (212) is formed by the first engaging structure (211), the track lap structure (214) and the baffle plate (213), and the anti-detachment structure provided on the inner surface of the track (22) extends into the limiting structure (212).

6. The pool cleaning robot with a track lap structure according to claim 5, wherein the pool cleaning robot further comprises a decorative plate, and the decorative plate is sealed to the baffle plate (213) and the track (22) to prevent contaminants from entering between the wheel (21) and the track (22).

7. The pool cleaning robot with a track lap structure according to claim 1, wherein the limiting structure (212) is a limiting groove, and the anti-detachment structure provided on the inner surface of the track (22) is a limiting protrusion (222) fitted with the limiting groove.

8. The pool cleaning robot with a track lap structure according to claim 2, wherein the limiting structure (212) is a limiting groove, and the anti-detachment structure provided on the inner surface of the track (22) is a limiting protrusion (222) fitted with the limiting groove.

9. The pool cleaning robot with a track lap structure according to claim 3, wherein the limiting structure (212) is a limiting groove, and the anti-detachment structure provided on the inner surface of the track (22) is a limiting protrusion (222) fitted with the limiting groove.

10. The pool cleaning robot with a track lap structure according to claim 4, wherein the limiting structure (212) is a limiting groove, and the anti-detachment structure provided on the inner surface of the track (22) is a limiting protrusion (222) fitted with the limiting groove.

11. The pool cleaning robot with a track lap structure according to claim 5, wherein the limiting structure (212) is a limiting groove, and the anti-detachment structure provided on the inner surface of the track (22) is a limiting protrusion (222) fitted with the limiting groove.

12. The pool cleaning robot with a track lap structure according to claim 6, wherein the limiting structure (212) is a limiting groove, and the anti-detachment structure provided on the inner surface of the track (22) is a limiting protrusion (222) fitted with the limiting groove.

13. The pool cleaning robot with a track lap structure according to claim 7, wherein the first engaging structure (211) comprises engaging grooves distributed at intervals along a circumferential direction of the wheel (21), and the at least part of the track (22) that is fitted with the first engaging structure (211) is engaging teeth (221), the engaging teeth (221) are provided on the inner surface of the track (22), and are fitted with the engaging grooves.

14. The pool cleaning robot with a track lap structure according to claim 13, wherein a depth of the engaging grooves in a radial direction of the wheel (21) is smaller than a depth of the limiting groove in the radial direction of the wheel (21), and a height of the engaging teeth (221) is smaller than a height of the limiting protrusion (222).

15. The pool cleaning robot with a track lap structure according to claim 14, wherein the engaging teeth (221) and the limiting protrusion (222) are sequentially arranged in a width direction of the track (22).

16. The pool cleaning robot with a track lap structure according to claim 1, wherein the limiting structure (212) is continuous in a circumferential direction of the wheel (21).

17. The pool cleaning robot with a track lap structure according to claim 2, wherein the limiting structure (212) is continuous in a circumferential direction of the wheel (21).

18. The pool cleaning robot with a track lap structure according to claim 3, wherein the limiting structure (212) is continuous in a circumferential direction of the wheel (21).

19. The pool cleaning robot with a track lap structure according to claim 1, wherein anti-skid protrusions are provided on an outer peripheral surface of the track (22), and the anti-skid protrusions are sequentially arranged at intervals along a circumferential direction of the track (22).

20. The pool cleaning robot with a track lap structure according to claim 2, wherein anti-skid protrusions are provided on an outer peripheral surface of the track (22), and the anti-skid protrusions are sequentially arranged at intervals along a circumferential direction of the track (22).
